(19) United States
(12) Patent Application Publication
(10) Pub. No.: US 2002/0093568 A1
(43) Pub. Date: Jul. 18, 2002

(54) Postage and passport photo self-service kiosk

(76) Inventor: Gregory R. Chumbley, Fort Lauderdale, FL (US)

Correspondence Address: Robert M. Downey, P.A., Suite 350, 150 East Palmetto Park Road, Boca Raton, FL, 33432, US

(21) Appl. No.: 09/761,138

(22) Filed: Jan. 16, 2001

(51) Int. Cl. H04N 5/225

(52) U.S. Cl. 348/207; 348/143

(57) ABSTRACT

An apparatus for producing and printing a photograph includes a touch-screen CRT display, a currency receiving and dispensing device, a remote control device for adjusting location of a photo image area on the CRT display and controlling capture of a photo image of the user from a video camera lens and controller board, and a printer, all connected to a central processor. Video impressions viewed by the camera lens are converted into a series of electrical impulses which are selectively captured and digitized. Thereafter, a digitized photo image of the user is either combined with a stored postage meter image for printing by the printer to produce a printed picture on one side of an adhesive-backed postage meter strip, or, alternatively, uploaded by a high-speed modem to a host computer for processing a passport.

### BACKGROUND OF THE INVENTION

1. Field of the Invention

This invention relates generally to a photography apparatus for producing printed pictures, and more specifically to an apparatus adapted to generate a digitized photo image to be either combined with a postage meter image and/or related postal indicia for printing on a plurality of adhesive-backed postage meter strips, or uploaded to a host computer.

2. Description of the Related Art

Postage stamps bearing the portrait of a famous person or historical site have long been an item of interest, especially to stamp collecting enthusiasts. The release by Federal Post Offices of stamps bearing the portraits of famous celebrities has heightened the general public's interest and demand for “special issue” stamps. In view of the public's infatuation with these novelty stamps, it is believed that many postage purchasers would find it exciting to have their personal photo on a stamp. However, the Federal Postal Regulations of most countries prohibit the application of a personal photograph, or other personal artistic expressions, to a stamp. On the other hand, it may be permissible to apply such a personal photo to a postage meter strip, wherein a printing device applies certain images representing a value of postage to a strip of adhesive backed paper or other suitable photographic medium.

In light of this, there is a need for a device having the ability to combine a personalized photograph with a value of postage (pre-determined or otherwise) on an adhesive-backed postage meter strip for subsequent application to an envelope, postcard, or other item of mail.

In the field relating to photograph vending apparatus, it is known to provide a self-service photo booth or apparatus for taking one's portrait without the services of a photographer. Apparatus of this type are generally operable by depositing money through a currency receiving mechanism, prompting a camera to take one or more photographs of an individual. The photographs are thereafter developed by wet chemicals within the apparatus and then dispensed to the purchaser after several minutes. In some instances, backgrounds are provided to create a personalized photo, which can be used as a postcard. This has been accomplished by use of various methods, including the use of fixed or interchangeable backdrops behind the persons being photographed.

More recently, self-service photo machines have been equipped with computers, enabling a user to quickly select a backdrop scene from a collection of computer-stored backgrounds. An example of this type of apparatus is disclosed in U.S. Pat. No. 5,343,386 to Barber. In this particular apparatus, a self portrait of the user is integrated with the selected background scene, wherein the combined photo is thereafter color printed on a postcard having pre-printed areas on an opposite side for application of postage, address, and a message.

Self-service photo machines may also be useful for obtaining paper passport photos. However, in an attempt to curb fraudulent misuses of its passports, such as switching passport photographs with that of someone other than the true passport holder, Federal Passport Agencies are currently developing systems wherein passport photographs will be scanned by a digital camera or flatbed scanner means and combined with the holder's name, address, date of birth, and all other pertinent information as required on passports. The resultant digitized photograph, combined with the pertinent information of the holder, will be printed on an adhesive-backed clear plastic film, similar in appearance to an overhead projection cell. This film can then be adhered to the inside of a passport and forwarded to the proper passport applicant.

In light of the fact that Federal Passport Agencies may no longer utilize paper photographs for adherence to its issued passports, but instead utilize digital photo image files, there is a need for a device that produces digital photo image files in such places as post offices, courthouses, etc. In this manner, the digital photo image files can be uploaded to the Passport Agency's central computer by high-speed modem in lieu of scanning a paper photograph in order to create the digitized photograph.

In spite of the various applications uses for which self-service photo machines have been adapted, none have combined the purchase of a personalized photograph with the purchase of postage. More specifically, there has not been developed an apparatus that integrates a personalized photograph with a plurality of adhesive-backed postage meter strips (representing a value of postage, pre-determined or otherwise) for subsequent application to an item of mailing. Furthermore, the photograph machines in the related art fail to provide a means to store a digitized photo image for subsequent uploading to a Federal Passport Agency computer for use in processing a passport application.

Accordingly, the present invention provides for the novel combination of a personal photograph integrated with a value of postage and printed on a plurality of adhesive-backed postage meter strips, as well as the uploading of a digitized photo image to a host computer.

### SUMMARY OF THE INVENTION

The present invention is directed to an apparatus for producing a photograph integrated with a postage meter image displaying a particular value of postage on an adhesive-backed postage meter strip. In accordance with the apparatus of the present invention, there is provided a touch-screen CRT display, a currency receiving and dispensing device, a remote control device, a central processor, a disk drive, a high-speed modem, a video camera lens with a controller board positioned and disposed to view and receive a video impression of the user, a receipt printer, and a suitable printer means for printing the captured video impression in combination with a stored postage meter image on the meter strip.

The apparatus is primarily intended for installation in post offices as a convenient means for consumers to purchase personalized postage meter strips.

It is a further object of the invention to provide a means for creating passport photo image files. Thus, the present invention eliminates the need to search for a passport photographer, make an appointment, and then travel to the location for passport photo session.

The photo image files are uploaded by the device to Federal Passport Processing Centers by high-speed modem communications and can be imported directly into the Agency's passport processing software without the necessity of subsequent scanning by the Agency. No device has been developed that provides a self-service means whereby, for a nominal charge, consumers can capture a digital photo image of themselves that is suitable for use by a Federal Passport Agency in issuing to them a valid passport.

In operation, the user simply approaches the apparatus, where he or she is prompted with easy-to-follow instructions appearing on the touch-screen CRT display. After selecting “Passport Photo” or “PhotoStamp,” the user deposits the indicated amount of money through the currency receiving and dispensing device.

If the user selects “Passport Photo,” he or she is then instructed on how to use the remote control device for adjusting the camera lens and capturing the photo image when ready. The user is further instructed to stand directly on top of a pair of shoe silhouettes that are affixed to the floor approximately 6 feet from the camera lens and capture (or freeze) the image that appears in the CRT display at will. Depending on the surroundings of a particular location, a neutral color backdrop may be provided, positioned directly behind the shoe silhouettes.

Within approximately 30 seconds after the passport photo image has been captured by the user, duplicate receipts are dispensed by the thermal receipt printer; one copy is retained by the user, the other is given to a passport agency by the user, who in turn attaches the receipt to the passport application in lieu of the customary two-inch by two-inch paper passport photo (at 100 to 300 dpi of resolution). The receipt also displays a Passport Agency File Number in Bar Code form, a date/time stamp, location number, and any other pertinent information as may be required by a Federal Passport Agency.

At pre-determined intervals, the device logs onto a host computer via high-speed modem and uploads the passport photo image files created since the last upload to a Federal Passport Processing Center or Centers, or to a designated site on the Internet. Once uploaded, the files are stored until retrieved by a Federal Passport Processing Center.

A particular photo image file is retrieved by its file name, i.e., the Federal Passport Agency file number appearing on the applicant's receipt. which may be read into the Agency's host computer by a bar code reader device. After the passport photo image file has been created and receipts issued to the user, the touch-screen CRT display will solicit the user to purchase a postage stamp with the photo image printed on the stamp, referred to hereinafter as a “PHOTOSTAMP.”

If the user purchases a passport photo image and then decides to purchase a PHOTOSTAMP, the PHOTOSTAMP may be created with the same photo image that was created for the passport. Alternatively, the user can elect to capture a new photo image for use on the PHOTOSTAMP if he or she so desires. The user simply deposits an additional sum of money through the currency receiving and dispensing device and follows the instructions appearing on the touch-screen CRT display. If no new photo image is to be taken, a suitable printer means will dispense the PHOTOSTAMP, or a plurality thereof, within 30 to 60 seconds.

If the user elects to capture a new photo image for the PHOTOSTAMP, the user is instructed to stand directly on top of the pair of shoe silhouettes that are affixed to the floor approximately 6 feet from the camera lens. The camera is activated and the user can capture (or freeze) the image that appears in the CRT display at will, using the remote control device.

With the foregoing in mind, it is a primary object of the present invention to provide an apparatus for producing a personalized photograph integrated with a postage meter image displaying a value of postage on an adhesive-backed postage meter strip for subsequent application to an envelope, postcard, or other item of mail.

It is a further object of the present invention to provide an apparatus, as set forth above, adapted to produce passport photo image files for uploading to a Federal Passport Processing Center or Centers, or its site on the Internet, via high-speed modem communications.

It is still a further object of the present invention to provide a convenient means for purchasing a PHOTOSTAMP, comprised of a plurality of adhesive-backed postage meter strips bearing a personalized photograph of the consumer, along with a postage meter image representing a value of purchased postage, with the added option of purchasing and capturing a passport photo image file to be later utilized by a Federal Passport Processing Center in lieu of a standard paper photograph.

It is still a further object of the present invention to provide a self-service photograph apparatus which can be conveniently installed in post offices or other suitable locations, eliminating the need to engage the services of passport photographers. These and other objects and advantages will be more readily apparent in the description which follows.

### BRIEF DESCRIPTION OF THE DRAWINGS

For a fuller understanding of the nature of the present invention, reference should be had to the following detailed description taken in connection with the accompanying drawings in which:

FIG. 1 is a block diagram of the functional component elements of the apparatus of the present invention;

FIG. 2 is a front view of the apparatus, showing the front face thereof;

FIG. 3 is a side view illustrating a preferred installation setup of the apparatus;

FIG. 4A is a side elevation of a backdrop used in connection with the apparatus;

FIG. 4B is a top plan view of the backdrop of FIG. 4A;

FIG. 5 is a top plan view of an example PHOTOSTAMP produced by the apparatus; and

FIG. 6 is a top plan view of an example passport photo image receipt produced by the receipt printer.

Like reference numerals refer to like parts throughout the several views of the drawings.

### DETAILED DESCRIPTION OF THE PREFERRED EMBODIMENT

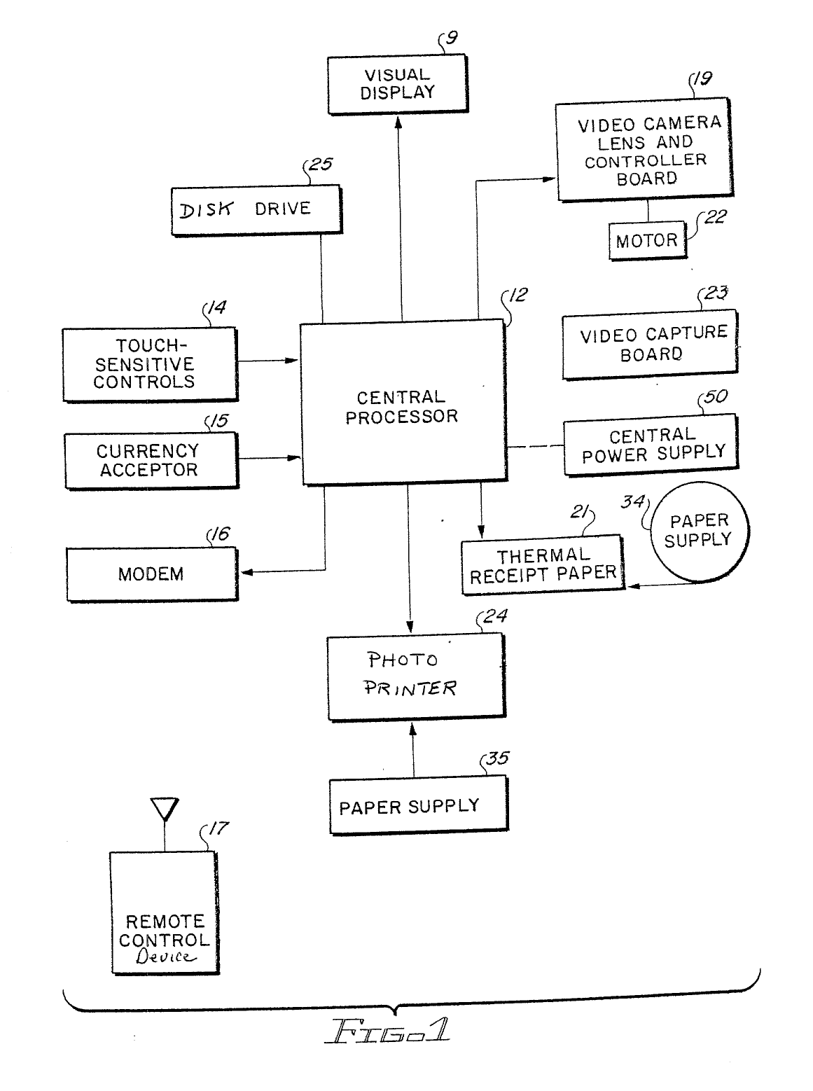

Referring initially to FIG. 1, there is illustrated, in block diagram form, the component elements of the photo and postage apparatus 10, with the controlling interaction between the various components being indicated by the interconnecting arrows. In accordance with a preferred embodiment of the present invention, the apparatus 10 includes a central processor 12 which is programmed with a series of instructions that define operating sequences in response to signals received from the touch-screen CRT display 14, a disk drive 25, high-speed modem 16, a currency receiving and dispensing device 15, a remote control device 17, a video camera lens with a controller board 19, a video capture board 23, a receipt printer 21, and a suitable printer means 24 for printing the PHOTOSTAMPS. The various components of the apparatus 10 are powered by a central power supply 50.

The program in the central processor further provides operating instructions which are transmitted to the touch-screen CRT display 14, prompting a user to deposit a predetermined amount of money to operate the apparatus and to further enter various operating commands on the touch-screen CRT display 14. Initiation of the primary operating sequences is triggered by depositing at least a specified amount of money through the currency receiving and dispensing device 15. A disk drive 25 is provided for storing the passport photo image files for uploading via the high-speed modem 16. A memory source is provided on the central processor 12 for storing the postage meter image and/or other postal indicia 40 of the type similarly printed on current postage meter strips and representing a value of postage paid.

A video viewing means includes a video camera lens and controller board 19 structured and disposed for viewing and receiving a video impression and for converting the received impression into a series of electrical impulses. The video camera lens and controller board 19 is generally of the type found in a common hand-held video camcorder or video camera, and is interconnected to and activated by the central processor 12. A motor 22, controlled by the central processor 12, adjusts the angle of the video camera lens relative to the subject being photographed so that the subject's head is correctly centered vertically within a defined image area on the CRT display 14. The central processor 12 operates motor 22 in response to command signals received by the hand-held remote device 17. The electrical impulses representing the viewed and received video impression are delivered from the controller board 19 to a video capture board 23, where the electrical impulses are digitized and stored for subsequent transfer to the central processor 12. The timing of the transfer of the digitized signals (representing at least a single frame of video) is determined by the program in the central processor 12 in accordance with the defined operating sequence.

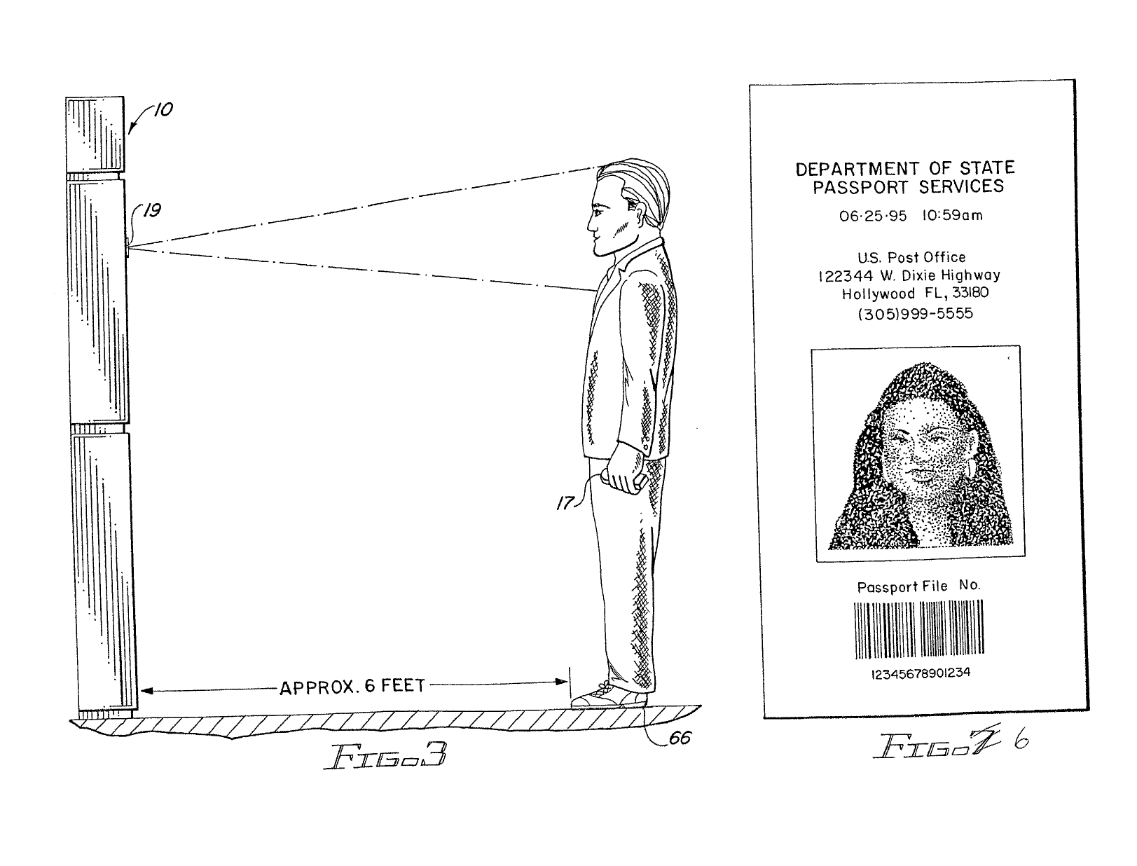

The captured digitized signals, representing the received video impression, are thereafter integrated with the stored postage meter image and/or other postal indicia in the memory source on the central processor 12. Thereafter, the integrated image (video impression and postage meter image) is transferred from the central processor 12 to a suitable printer means 24, which is activated in sequence in response to a series of instructions by the program in the central processor 12. The combined images are delivered to the suitable printer means 24 in the form of electronic impulse signals. The impulse signals are converted into a photograph, representing the viewed video impression and the postage meter image, and printed on a plurality of adhesive-backed postage meter strips 40. The plurality of postage meter strips 40 are dispensed from a metered paper supply 35 for individual delivery to the suitable printer means 24 upon demand. After printing, the plurality of postage meter strips 40 are dispensed and delivered to the user bearing the user's photograph (see FIGS. 5 and 6).

The program in the central processor further provides for the production of properly sized passport photo image files, wherein the postage meter indicia images are not integrated with the photo image file. In this particular instance, the captured electrical impulses, representing the viewed video impression, are transferred from the central processor 12 to the disk drive 25 without integration with the postage meter images, so that only a passport photo image file is produced and stored on the disk drive 25. The stored passport photo image file is subsequently uploaded to a host computer via the high-speed modem 16.

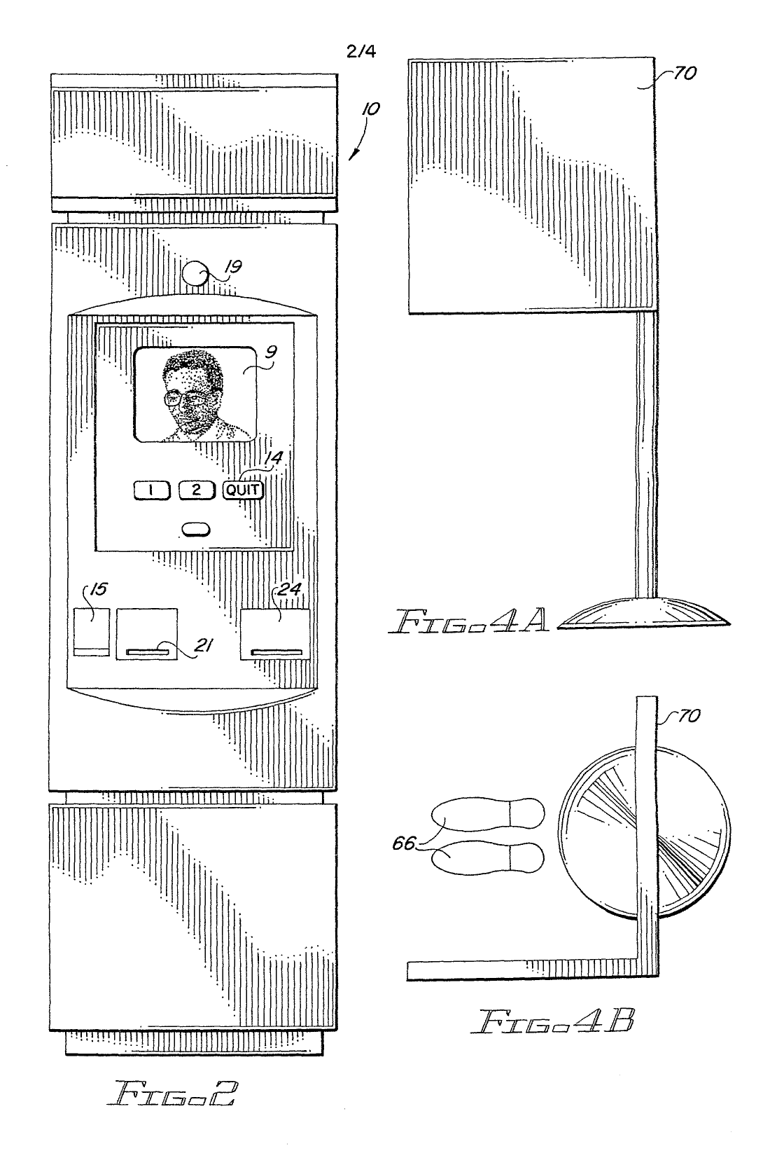

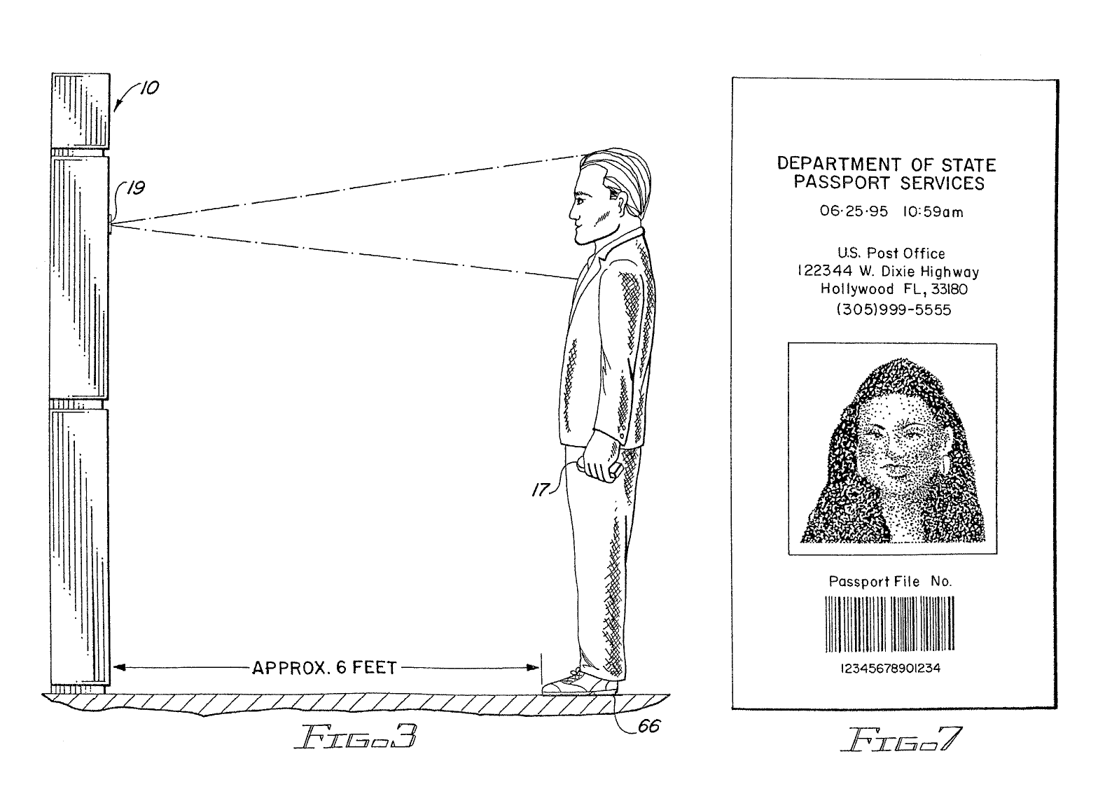

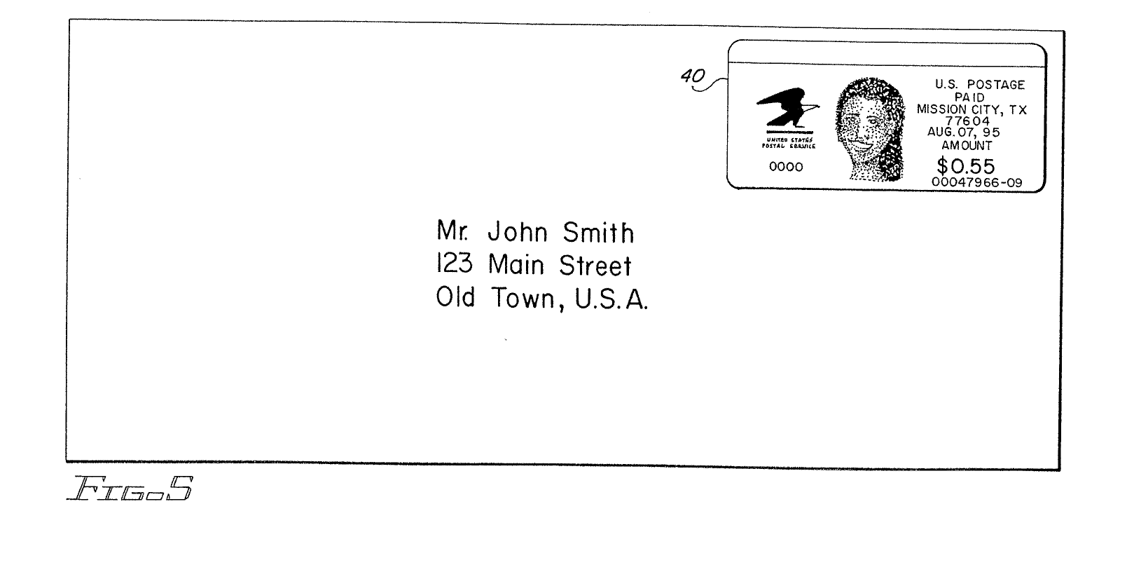

Referring to FIGS. 2 and 3, the apparatus 10 is shown within an upright enclosure in accordance with what may be a preferred commercial installation. In operation, the user would approach the exposed face of the apparatus 10 where he or she is prompted with easy-to-follow instructions appearing on the touch-screen CRT display 14. After depositing the required amount of money through the currency acceptor 15 and making appropriate entries via the touch-screen CRT display 14, the user is instructed to place his/her feet directly on top of a pair of shoe silhouettes 66, which are affixed to the floor approximately 6 feet from the camera lens 19 (see FIG. 3). A neutral backdrop 70 may be positioned directly behind the shoe silhouettes 66.

Each apparatus can be individually programmed to provide specific identifying postal indicia on the PHOTOSTAMP. Using the touch-screen CRT display 14, a special security code number specific to a particular apparatus 10 is entered to enable programming of specific data. In particular, the user, such as the post office, can enter the city, state, zip code, current date, and any other pertinent data in the central processor 12. This information is stored in the memory of the central processor. The entered data is used to produce a completed PHOTOSTAMP. The date (and time, if applicable) which is printed on the PHOTOSTAMP is maintained by the central processor's built-in clock. The apparatus 10 further has the capability of generating reports. In particular, a report of the day's activity (e.g., number of PHOTOSTAMPS and/or passport photo image files created), plus a running total of the money received, is output on demand via the thermal receipt printer 21.

While the invention has been shown and described in what is considered to be a practical and preferred embodiment, it is recognized that departures may be made within the spirit and scope of the following claims, which therefore, should not be limited except within the doctrine of equivalents.

Now that the invention has been described,

What is claimed is:

1. An apparatus for producing photographs comprising:
input means for entering operational selections to generate control signals;
a central processor programmed with a series of instructions that define operating sequences responsive to received signals including said control signals, and including a memory having files for storing at least one postage meter image representing a value of postage;
video viewing means including a video camera lens and a controller board structured and disposed for viewing and receiving a video impression and being further structured to convert said received video impression into a series of electrical impulses;
video capture means connected to said central processor and said video viewing means for selectively receiving and digitizing a select group of said series of electrical impulses to create a digitized photo image for subsequent transfer to said central processor; and
printer means connected to said central processor and activated in sequence in response to said series of instructions, and being structured and disposed to receive electronic impulse signals, including electronic impulse signals comprised of the combination of said digitized photo image and said postage meter image, from said central processor and to print indicia on a substrate, said indicia including a visual production of the digitized photo image combined with the postage meter image.

2. An apparatus as recited in claim 1 wherein said input means includes a CRT display having screen sensitivity means responsive to touch to generate said control signals.

3. An apparatus as recited in claim 2 wherein said input means further includes hand-held or other remote control means.

4. An apparatus as recited in claim 3 wherein said CRT display is structured and disposed to receive said series of electrical impulses and to further display said viewed video impression.

5. An apparatus as recited in claim 4 wherein said viewed video impression is displayed on said CRT display within a defined photo image area on said CRT display.

6. An apparatus as recited in claim 5 further including means for adjusting and controlling location of said photo image area on said CRT display.

7. An apparatus as recited in claim 6 wherein said means for adjusting and controlling location of said photo image area on said CRT display is responsive to signals from said hand-held or other remote control means.

8. An apparatus as recited in claim 7 further including means for selectively adjusting the position of said video camera lens through a range of adjusted positions.

9. An apparatus as recited in claim 8 wherein said means for selectively adjusting the position of said video camera lens is operable in responsive to said signals from said hand-held or other remote control means.

10. An apparatus as recited in claim 1 further including means for storing said digitized photo image.

11. An apparatus as recited in claim 10 further including means for uploading said digitized photo image to a host computer.

12. An apparatus as recited in claim 11 wherein said means for uploading includes modem means.

13. An apparatus for producing photographic image files comprising:
input means for entering operational selections to generate control signals;
a central processor programmed with a series of instructions that define operating sequences responsive to received signals including said control signals;
camera means for viewing an image and converting the viewed image into a series of electrical impulses;
means for capturing at least a portion of said series of electrical impulses;
means for digitizing said captured series of electrical impulses to create a digitized photo image;
means for storing said digitized photo image; and
means for uploading said stored digitized photo image to a host computer.

14. An apparatus as recited in claim 13 wherein said means for uploading includes modem means.

15. An apparatus as recited in claim 14 wherein said modem means is a high-speed modem.

16. An apparatus for producing photographic image files comprising:
input means for entering operational selections to generate control signals;
a central processor programmed with a series of instructions that define operating sequences responsive to received signals including said control signals, and including a memory having files for storing at least one postage meter image representing a value of postage;
video viewing means including a video camera lens and a controller board structured and disposed for viewing and receiving a video impression and being further structured to convert said received video impression into a series of electrical impulses,
means for capturing at least a portion of said series of electrical impulses;
means for digitizing said captured series of electrical impulses to create a digitized photo image;
means for storing said digitized photo image;
means for selectively uploading said stored digitized photo image to a host computer;
means for selectively combining said stored digitized photo image with said stored postage meter image; and
printer means connected to said central processor and activated in sequence in response to said series of instructions, and being structured and disposed to receive electronic impulse signals, including electronic impulse signals comprised of the combination of said digitized photo image and said postage meter image, and to print indicia including a visual production of the digitized photo image combined with the postage meter image on a substrate.

17. An apparatus as recited in claim 16 wherein said printer means includes a first printer for printing receipts and a second printer for receiving the combined digitized photo image and postage meter image and printing the visual production on the substrate.

18. An apparatus as recited in claim 17 wherein said first printer is a thermal printer.

19. A process for producing photographic image files comprising the steps of:
viewing an image with camera means and converting the viewed image into a series of electrical impulses;
capturing at least a portion of said series of electrical impulses;
digitizing said captured series of electrical impulses to create a digitized photo image;
uploading said stored digitized photo image to a host computer;
storing said digitized photo image on said host computer; and
subsequently retrieving said digitized photo image for processing a passport.
